(19) United States
(12) Patent Application Publication
(10) Pub. No.: US 2012/0016624 A1
(43) Pub. Date: Jan. 19, 2012

(54) DEVICE AND METHOD FOR CHARACTERIZING MOVEMENTS

(75) Inventors: Yanis Caritu, Saint Joseph La Riviere (FR); Christelle Godin, Brignoud (FR); Grégoire Aujay, Grenoble (FR); Etienne De Foras, Saint Nazaire Les Eymes (FR)

(73) Assignees: Commissariat A L'Energie Atomique et aux Engeries Alternatives, Paris (FR); Moves, Grenoble (FR)

(21) Appl. No.: 13/143,319

(22) PCT Filed: Dec. 29, 2009
(86) PCT No.: PCT/EP09/67973

§ 371 Date: Sep. 28, 2011

Related U.S. Application Data
(60) Provisional application No. 61/142,408, filed on Jan. 5, 2009.

(51) Int. Cl. G06F 15/00

(52) U.S. Cl. 702/141

(57) ABSTRACT

The invention proposes a device and a method for characterizing movements performed by an object, notably a limb of a human being instrumented with at least one accelerometer. The invention is particularly useful for determining the direction, the line and the length of the steps of said human being. The invention uses algorithms for processing the signals from the sensor to make it possible to segment the steps by identifying the lifting and the landing of said limb by comparing the signals output from the sensor with thresholds, to determine the direction and the line of the step by comparing the maxima of the values of the signals along two axes substantially parallel to the walking plane and to calculate the length of the step by double integration of the signals according to the direction of the step. The invention is also applicable to hand movements that have trend characteristics similar to those of the steps.

This application is a national phase application under §371 of PCT/EP2009/067973, filed Dec. 29, 2009, which claims priority to U.S. Provisional Patent Application No. 61/142,408, filed Jan. 5, 2009, the entire content of which are expressly incorporated herein by reference.

The present invention applies to the field of motion capture. More specifically, it covers the detection of steps performed by a human being practicing dance, a walk or a run for gaming or training purposes. A typical application of the invention is the game “Dance Dance Revolution” (DDR) which is played in game arcades or with a console or a PC. In the current embodiment of this game, the player must execute a sequence of dance steps which is indicated to him on the screen, said sequence being paced by music. The player stands on a flexible or rigid mat comprising cells which may be aligned, arranged in a rectangle or in a square, the number of cells being able to vary from 4 to 6, or even 9. Each cell is instrumented by a device for detecting the presence of the player. The setpoints relating to the dance step sequence may be given by arrows indicating the cell toward which the player should move. Thus, the system can compare the sequence executed with the ideal sequence and assign a score to the player. However, this embodiment presents the drawback of requiring this detection mat which is bulky and costly if rigid and fragile and inaccurate if flexible. Furthermore, the mat limits the reach of the possible movements.

To remedy these drawbacks, the invention eliminates the presence detectors of said mat and replaces them with a motion capture device worn on at least one foot of the player and provided with processing capabilities that make it possible to detect the position of the player relative to the cells of a virtual mat (with a size and/or number of cells that can be as great as is required), or a real mat, but without instrumentation.

To this end, the invention provides a device for characterizing movements of an object comprising at least one accelerometer fastened to said object and a computation module, said computation module being capable of using the outputs of said at least one accelerometer to execute at least one function for segmenting said movements into individual movements between a first position and a second position, and, for each individual movement, at least one function for determining the direction and the line of displacement of said individual movement relative to at least one axis linked to the object.

Advantageously, said first and second positions correspond to instants during which said object is substantially immobile or has been affected by an impact.

Advantageously, the computation module is capable of also executing at least one function for calculating the length of the individual movement in the direction of the movement.

Advantageously, said object is a foot or a hand of a human being.

Advantageously, said computation module is also capable of executing a function for assessing the conformity of the movements of the object relative to a sequence of prerecorded movements.

Advantageously, said computation module is also capable of executing a function for controlling the displacements of a virtual object representing the object in real movement on a display linked to said computation module, said displacements logically and quantitatively corresponding to said movements.

Advantageously, the device of the invention also comprises at least one magnetometer fastened to the object and said computation module is capable of also using the outputs of said at least one accelerometer and of said at least one magnetometer to execute a function for determining the orientation of said object in at least one plane.

To operate the device, the invention also provides a method for characterizing movements of an object comprising at least one step for capturing the output signals from at least one accelerometer fastened to said object and a step for calculation by a processor, wherein, during said calculation step, the outputs from the step for capturing the output signals from at least one accelerometer are used to execute at least one function for segmenting said movements into individual movements between a first position and a second position, and, for each individual movement, at least one function for determining the direction and the line of displacement of said individual movement relative to at least one axis linked to the object.

Advantageously, during said calculation step, at least one function for calculating the length of the individual movement in the direction of movement is also executed.

Advantageously, said calculation step also comprises, when the elevation of the accelerometer over the object is substantially greater than 20°, a step for calibrating the measurements output from the step for capturing the output signals from the accelerometer.

Advantageously, said individual movement segmentation function comprises a step for centering on the average value of measurements output from at least one axis of the accelerometer.

Advantageously, said individual movement segmentation function also comprises a filtering step based on calculation of at least one sliding average of said centered measurements.

Advantageously, said individual movement segmentation function comprises a step for calculating a norm of at least one measured or calculated value output from the accelerometer then for comparing said norm to a predetermined threshold to deduce the start or the end of the individual movement therefrom.

Advantageously, said individual movement segmentation function processes only the measurements over a time horizon greater than a predetermined value.

Advantageously, said individual movement segmentation function processes only the measurements beginning at the end of a first chosen time interval following the start of an individual movement and ending at the start of a second chosen time interval preceding the end of said individual movement.

Advantageously, said function for determining the direction of the individual movement comprises a step for calculating the maxima of the absolute values of the integrals of the measurements along each of two axes substantially parallel to the plane of the individual movements on the signal sample determined at the output of the individual movement segmentation function, then a step for comparing the maximum along one of the axes with the maximum on the other axis, the direction of the individual movement being determined as being that of the axis of the maximum.

Advantageously, said function for determining the direction of the individual movement comprises a step for calculating the maxima of the absolute values of the integrals of the measurements along each of two axes substantially parallel to the plane of the individual movements on the signal sample determined at the output of the individual movement segmentation function, then a step for calculating the ratio of the maxima along the two axes, the direction of the individual movement being determined as forming an angle with the axis whose maximum is the denominator of said ratio for which the tangent is equal to said ratio.

Advantageously, said function for determining the line of the individual movement comprises, at the output of the step for determining the direction of an individual movement, a step for determining the signs of the maxima along said two axes, said sign determining the line of the individual movement in the determined direction.

Advantageously, said function for calculating the length of the individual movement comprises a step for double integration of the absolute values of the measurements along the direction of the individual movement determined at the output of the function for determining the direction and the line of the individual movement.

The invention also discloses a system for evaluating the movements of an object comprising a master scenario of reference movements to be executed by said object, a control interface of said reference movements of said object, at least one first uniform field sensor, said sensor being fastened to said object, a calculation module, said module being capable to execute from the output of said first sensor, at least one function for segmenting said movements into individual movements between a first position and a second position, and, for each individual movement, at least one function for determining the direction and the line of displacement of said individual movement relative to at least one axis linked to the object, said movements of said object being executed in response to said reference movements.

The inventive device uses MEMS which are becoming increasingly inexpensive and is therefore inexpensive to produce. It is not bulky and is lightweight. It offers the advantage of being able to be used for other applications, for example other games or training systems in which it is also necessary to detect the direction of movement and the orientation of the feet of the player, such as quasi-static promenade or walking simulation games. The same device can be worn on the hand and used to detect the vertical and horizontal movements of said hand used to play music, or even to recognize the handwriting of the wearer. A combination of the inventive devices can also be worn on one or two upper limbs and one or two lower limbs, said combination making it possible to compare the motion sequences of the two categories of limbs to prerecorded ideal motion sequences, notably for training purposes, particularly for sports or games in which the coordination of the motions of said lower and upper limbs is a fundamental element of the learning process. The present invention, through its versatility, therefore provides significant advantages which do not limit its application to the field for which it is derived from the DDR game.

The invention will be better understood, and its various features and advantages will become apparent from the following description of a number of exemplary embodiments and from its appended figures in which:

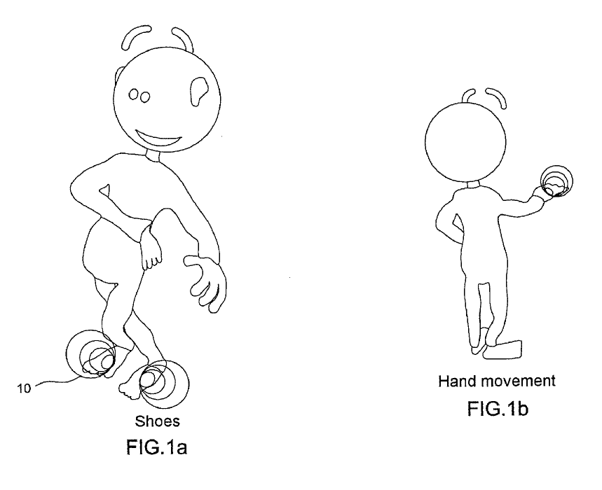

FIGS. 1a and 1b represent examples of positioning of devices according to the invention in a number of its embodiments;

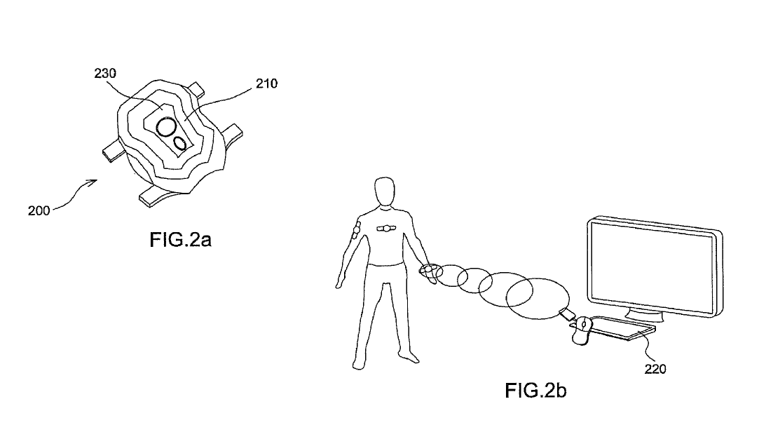

FIGS. 2a and 2b represent examples of sensors and of processing units for implementing the invention in one of its embodiments;

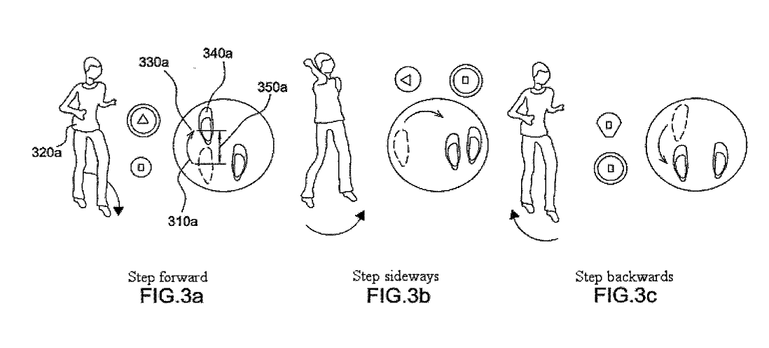

FIGS. 3a to 3c represent three types of dancer steps represented seen from above and detected by the inventive device in one of its embodiments;

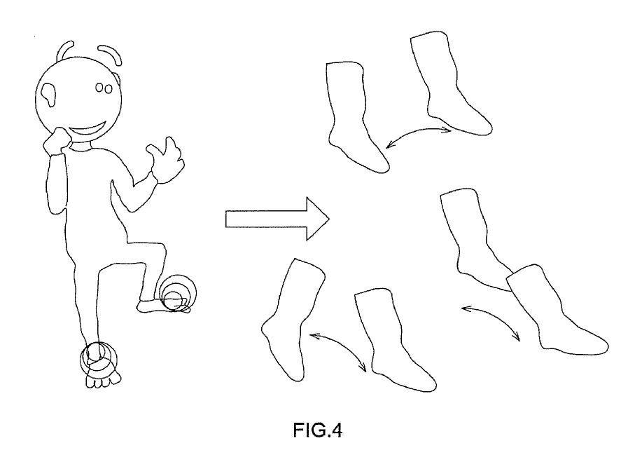

FIG. 4 represents the same three types of dancer steps represented in side view detected by the inventive device in one of its embodiments;

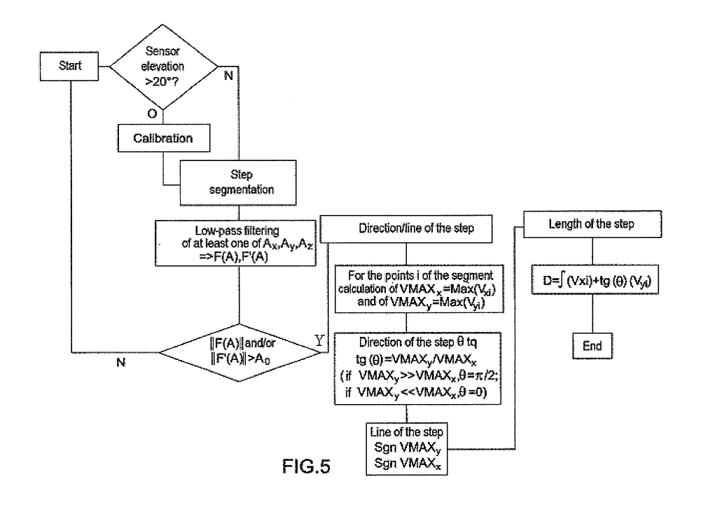

FIG. 5 is a flow diagram of the processing operations performed by the inventive device in one of its embodiments;

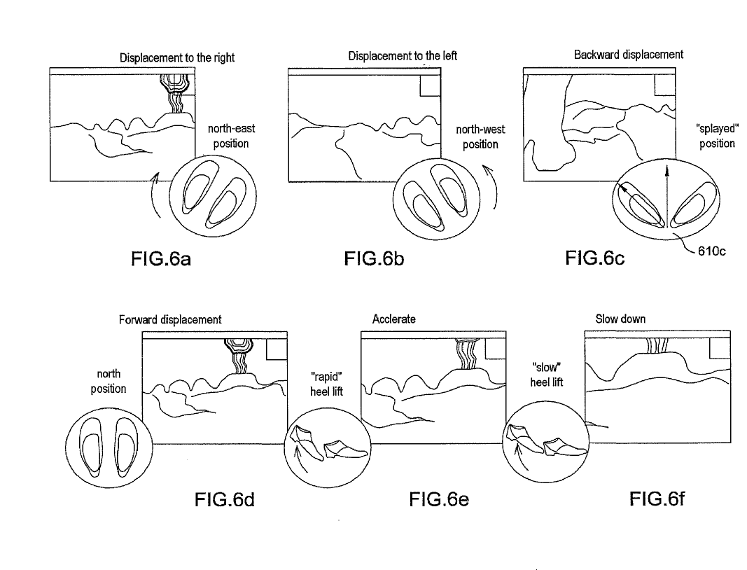

FIGS. 6a to 6f represent 6 types of displacement of a walker corresponding to 6 different positions of his shoes as detected by the inventive device in one of its embodiments;

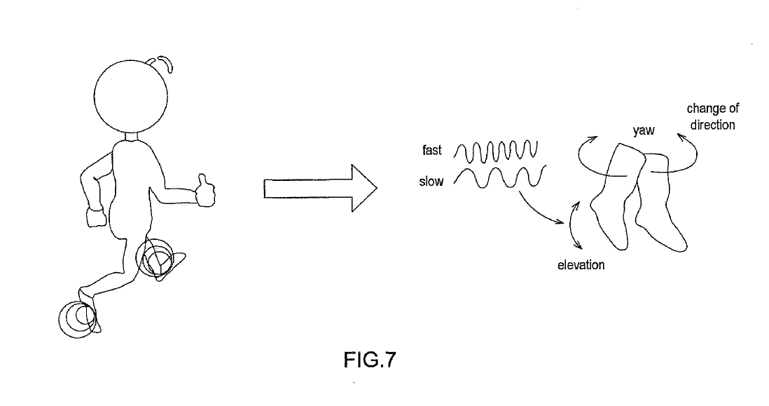

FIG. 7 represents in a simplified manner the processing operations performed to detect the displacements of FIGS. 6a to 6f;

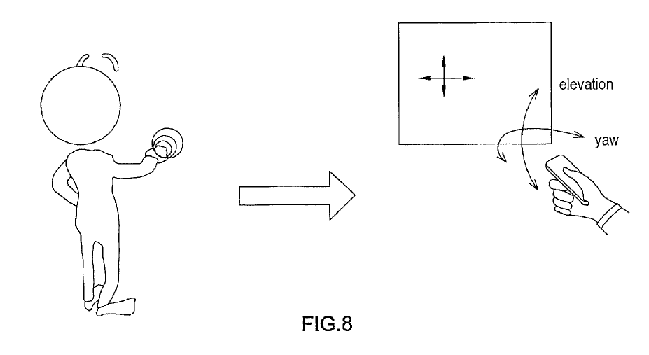

FIG. 8 represents an embodiment of the invention in which the device is worn by a hand.

FIGS. 1a and 1b represent examples of positioning of devices according to the invention in a number of its embodiments.

Unlike the embodiments of a DDR device of the prior art, a player can move around without an instrumented mat under his feet. In FIG. 1a, the player wears a sensor on each of his lower limbs, preferably under or on his shoes. The sensor may be incorporated in the sole or fixed by elastic bracelets to the top of his shoes or, possibly, fixed also by elastic bracelets to each of his ankles. The types of sensors that can be used are indicated as comments in FIG. 2a. Depending on the place where the sensors are fixed, a calibration may be necessary or useful, as explained in the comments to FIG. 5.

Identical devices can be used to play games other than DDR, notably walking simulation games or games that use musical instruments, for example percussion instruments.

In all cases, the motion capture devices are linked to a computation device remote from the player and linked to the game control and display device.

In other game scenarios, such as that represented in FIG. 1b, the player can wear a motion capture device on one or both hands whose movements will be analyzed to be compared to a guide scenario or to generate a command for a system linked to the computation module.

FIGS. 2a and 2b represent examples of sensors and of processing units for implementing the invention in one of its embodiments.

In DDR-type scenarios or other game scenarios, the player will wear, at judicially selected positions (below or above the shoe, ankle, wrist, etc.), a device 200 of the type of that represented in FIG. 2a which is a MotionPod™, although all the possibilities offered by a device of this type are not fully exploited in the embodiments envisaged in the context of the present invention. A MotionPod which, as such, is a prior art device, comprises an accelerometer 210 and a magnetometer 230. The two sensors are tri-axial. A mono- or bi-axial accelerometer may suffice in certain application cases (DDR in which all the cells provided to perform dance steps are situated in a single direction), one axis being used to detect the displacement, a second possible axis being used to detect the start of a motion. However, in most cases, a tri-axial accelerometer will be necessary to determine the direction of movement. A magnetometer can be used in combination with the accelerometer, notably to determine the orientation of the feet (yaw and pitch), as will be seen in the comments to FIG. 6c. Other uses of the magnetometer are also possible, this sensor offering the advantage over the accelerometer of providing access to the yaw measurements. The MotionPod also includes a preprocessing capability that makes it possible to preformat the signals from the sensors, a radiofrequency transmission module for the transmission of said signals to the processing module itself and a battery. This motion sensor is called “3A3M” (three accelerometer axes and three magnetometer axes). The accelerometers and magnetometers are market-standard micro-sensors with little bulk, low consumption and low cost, for example a three channel accelerometer from the company Kionix™ (KXPA4 3628) and Honeywell™ magnetometers of HMC1041Z type (1 vertical channel) and HMC1042L type for the 2 horizontal channels. There are other suppliers: Memsic™ or Asahi Kasei™ for the magnetometers and STMT™, Freescale™, Analog Device™ for the accelerometers, to name only a few. In the MotionPod, for the 6 signal channels, there is only one analog filtering stage and then, after analog-digital conversion (12 bits), the raw signals are transmitted by a radiofrequency protocol in the Bluetooth™ band (2.4 GHz) optimized for consumption in this type of application. The data therefore arrive raw at a controller connected to the computation module 220 of FIG. 2b. This controller may receive data from a set of sensors, for example two sensors, each being located on one of the shoes. The data are read by the controller and made available to the software. The sampling rate can be adjusted. By default, it is set to 200 Hz. Higher values (up to 3000 Hz, or even more) can nevertheless be envisaged, allowing for a greater accuracy in the detection of impacts for example.

The processing operations that make it possible to implement the invention and that will be presented as comments to FIG. 5 are located on the computation module 220 which may be resident on a central processing unit of a market-standard PC, a game console or a game arcade type computer system. The display of the computation module enables the player to view the setpoints that are given to him to execute the game scenario, so as to follow, if appropriate, the movements of his avatar in comparison to those of the model and in any case to be informed of his performance levels.

FIGS. 3a to 3c represent three types of dancer steps represented seen from above and detected by the inventive device in one of its embodiments.

As can be seen in the 3 FIGS. 3a, 3b and 3c, the basic scenarios of the DDR game reply on steps by the dancer forward (3a), sideways (3b) and backwards (3c). On a virtual dance mat with 9 cells arranged in a square, it is also possible to envisage diagonal steps which are not represented here. It is also possible to envisage extending the mat to the entire available ground area by increasing the number of cells, by changing the shape of the cells or their size.

As represented in FIG. 3a, the left foot leaves the position 310a where it is first placed by being lifted to reach the position 320a where it is put down once again. The trajectory 310a, 320a represents the flight phase of the foot characteristic of the step. The arc 330a represents the direction of the step, in this case in a forward line. The arrow 340a represents the line of the step in the direction. The quantity 350a represents the length of the step between lifting and lowering.

In a DDR device of the prior art, the pressure of the player on the sensor positioned under the new position of the foot 320a makes it possible to locate the latter at the moment of placement of the foot on one of the cells of the mat and thus deduce the step made. On the other hand, in the dance game device according to the invention, as suggested by the 3 FIGS. 3a, 3b and 3c, the sensor worn by the foot of the player makes it possible to follow the trajectory of the foot by detecting its lifting and/or its placement and by determining the direction, the line and the length of the displacement.

FIG. 4 represents the same three types of dancer steps represented in side view detected by the inventive device in one of its embodiments.

FIG. 4 breaks down the lifting and lowering of the foot of the player which determine the start and the end of the step. These are the two instants which can be detected by the accelerometer 210 in the 3 cases of the figure, as in the other cases. These two instants are in fact moments of discontinuities in the readings of the accelerometer which will be isolated by the processing operations according to the invention which are explained hereinbelow in the description. This processing is used to segment the movements and therefore to determine a step.

FIG. 5 is a flow diagram of the processing operations performed by the inventive device in one of its embodiments.

The sensor may be in any orientation on the shoe, but it may be necessary to include in the processing operations a calibration step prior to the computation steps, notably when the coordinate system of the accelerometer forms an angle substantially greater than 20° with the horizontal plane. An exemplary calibration is described as anatomical calibration or module calibration—the module then being the shoe—in the European application published under the number EP1985233 and belonging to the same applicants. Below 20°, the processing is robust to this orientation defect. Otherwise, the calibration step makes it possible to retrieve the orientation of the sensor on the shoe and to switch to virtual axes in the directions linked to the shoe. In the following steps, a measurement is then available along the vertical axis, along a horizontal axis oriented forwards (from the heel to the toe of the shoe) and along another horizontal axis perpendicular to the heel-toe axis and oriented toward the left of the person wearing the shoes.

Determining the step then involves the following steps:
segmentation of the step;
determination of the direction and the line of the step;
if necessary, determination of the length of the step.

### 1/ Step Segmentation

As indicated in FIG. 4, the first step is to determine the moments of raising and lowering of the foot, or just the lowering. According to the application scenario, measurements from just one axis of the accelerometer, from 2 or 3 axes, can be used. These measurements are used, depending on the steps of the calculation, in raw form, as absolute values, possibly with their drifts.

In a first embodiment, only the impact associated with the landing (lowering) is used for the segmentation. The direction detection calculation will then be run on the past, up to the preceding impact.

At least one of the data A_{X}, A_{Y} and A_{Z} received as output from the accelerometer 210 is processed by the computation module 220.

The foot lowering steps are the subject of an impact detection, based on an acceleration norm: an impact is detected if the absolute value or the norm of the acceleration measurement on one of the axes (for example the vertical: A_{Z}) exceeds a threshold determined by setting. Between two impacts, the signal is saved, and a series of values A_{X}, A_{Y} and A_{Z} called SA_{X}, SA_{Y} and SA_{Z} is obtained.

In a variant of this embodiment, to avoid false bounce occurrences, it is possible to process only the series of values (between two impacts) that have a significant number of measurements, which corresponds to a minimum time to perform the motion. Similarly, in a complementary variant provided to improve the detection of the translation, a portion of the signals at the start and at the end of the impact may possibly be removed, because they may contain measurements of the foot/ground impact and not of the translation.

In a second embodiment, it is also possible to detect, by thresholding, the take-off and landing to segment the step. In this embodiment, a combination of the accelerations along 1, 2 or 3 axes and the drifts of these values is used and compared to a threshold determined by setting. When this combination exceeds the threshold for a sufficiently long duration, the start of the step is detected. The end of the step is detected when it falls back below the threshold for a sufficiently long duration.

In a variant of this embodiment, a low-pass filtering of the values is performed over a sliding time window whose duration is also determined by setting.

At the end of this step, a time window is then available which is delimited by a start and an end, containing a step.

### 2/ Detection of the Direction and the Line of the Step

In the two embodiments of the preceding step, the procedure is identical. First, SA_{X} and SA_{Y} have their respective averages removed from them to find the specific acceleration of the sensor.

```
//example of code for removing the average
avg=0;
for(int i=0;i< SA_{X}.size( );i++)
    avg+= SA_{X} (i);
avg=avg/SA_{X}.size( );
for(int i=0;i< SA_{X}.size( );i++)
    SA_{X} (i)−=avg;
```

In practice, the measured acceleration contains the acceleration of gravity which is added to the specific acceleration of the sensor. In the case of a pure translation of the sensor, without rotation, the contribution of the acceleration of gravity is constant. Furthermore, the specific acceleration has a zero average between two impacts, since the speed is zero on departure and on arrival. Therefore:

at any moment:

A_{X}(i)=A_{XP}(i)+A_{xg}(i)

with A_{XP}=specific acceleration and A_{XG}=acceleration due to gravity, A_{X}=measured acceleration, integ representing the integral over the entire time window.

Then:

integ(A_{X})=integ(A_{XP})+integ(A_{XG})

Therefore: intake(A_{X})=intake(A_{XG}) since intake(A_{XP})=0 (given that the object is displaced between two points where the speed is zero, the deceleration preceding the lowering should strictly offset the acceleration following the raising).

If there is no rotation (simple step hypothesis), then A_{XG} is constant and it is possible to write integ(A_{XG})=avg(A_{XG}*nbpoints)=A_{XG}(i)*nbpoints, regardless of i. The following is found:

A_{XG}(i)=avg(A_{XG})

The following is deduced therefrom:

A_{XP}(i)=A_{X}(i)−A_{XG}(i)=A_{X}(i)−avg(A_{XG})

All that then remains is to integrate A_{XP} from 0 to i to find the instantaneous speed (still assuming the hypothesis of absence of rotation)

For this, the cumulative sums are calculated for SA_{X} and SA_{Y}, which gives the instantaneous speeds of VA_{X} and VA_{Y} of the sensor.

//example of code on SA_{X} and SA_{Y}
VA_{X}(0)= SA_{X}(0);
for(int i=1;i< SA_{X}.size( );i++)
VA_{X}(i)= VA_{X}(i−1)+ SA_{X}(i);

The maximum of VA_{X} is then sought as an absolute value of VA_{X}, denoted

```
Max_VA_{X}.
//example of code
Max_VAₓ= VA_{X}(0)
for(int i=1;i< SA_{X}.size( );i++)
    if(abs(Max_VA_{X})<abs(SA_{X}(i))
    Max_VA_{X} = SA_{X}(i);
```

The same procedure is then applied for VA_{Y}, the maximum of VA_{Y} as an absolute value being denoted Max_VA_{Y}. An example of code can easily be transposed from that given for VA_{X}.

It is then decided that the direction of translation (direction of the step) is that associated with the maximum of Max_VA_{X} and of Max_VA_{Y}.

The line of the pitch in each direction is then determined by the sign of Max_VA_{X} and Max_VA_{Y}.

```
//example of code for determining the line of the step
      if(abs(Max_VA_{X})>abs(Max_VA_{Y}))
      {
```

| | |
|---|---|
| if(Max_VA_{X} >0) | line=0 (positive line of the X axis); |
| else | line=1 (negative line of the X axis); |
| } | |
| else | |
| { | |
| if(Max_VA_{Y}>0) | line=2 (positive line of the Y axis); |
| else | line=3 (negative line of the Y axis); |
| } | |

In an advantageous variant embodiment, it is possible to use the two series VA_{X} and VA_{Y} or the two values Max_VA_{X} and Max_VA_{Y} to determine a diagonal direction of the step. In the first case (processing the series), it is possible to perform a main components analysis to find the correlation straight line between the two series which gives the direction of the step. In the second case, it is possible to calculate the ratio of the two maxima. In a first approximation, the ratio Max_VA_{Y}/Max_VA_{X} is the tangent of the angle θ of the direction of the step with the X axis. The line of the step can then be determined substantially in the same way as above: in this case, the line is determined both on X and on Y (for example positive on the X axis and negative on the Y axis); an angular direction is given but no classification is made (not in a cell). Once θ has been calculated, it is possible to decide whether it is a displacement along X, along Y, or along XY (diagonal): the trigonometrical circle can be divided into portions surrounding each direction: if θ<π/8 and θ>−π/8 then it is X; if θ>π/8 and θ<3*π/8 then it is XY; if θ>3*π/8 and θ<5*π/8 then it is Y.

In a third variant, it is possible to work directly on Maₓ_{_{—}}VA_{Y} and Max_VA_{X}. If |Max_VA_{X}|>s*|Max_VA_{Y}| then it is X, |Max_VA_{Y}|>s*|Max_VA_{X}| then it is Y; if |Max_VA_{X}|<s*|Max_VA_{Y}| with |Max_VA_{Y}|<s*|Max_VA_{X}| then it is XY.

In another variant embodiment, it is possible to integrate the Va_{X} and Va_{Y}, which gives the position at any instant Xaₓ and Xa_{y}, the chosen translation axis is then the axis which has the greatest displacement (in the preceding description, Va_{X} and Va_{Y} are replaced by the displacements Xaₓ and Xa_{y}).

Similarly, it is possible to replace Va_{X} (and Va_{Y}) with Sa_{X} (and Sa_{Y}), the cumulative sum of |Sa_{X}| (and |Sa_{Y}|): cumsum(|Sa_{X}|) (and cumsum(|Sa_{Y}|)).

In these three cases, Max_Va_{X} is replaced with Max_Xa_{X} or Max_Sa_{X} or Max(cumsum(|Sa_{X}|)), and Max_Va_{Y} is replaced with Max_Xa_{Y} or Max_Sa_{Y} or Max(cumsum(|Sa_{Y}|)).

### 3/ Optional Calculation of the Length of the Step

Once the direction is determined, a double integration is performed in this direction to calculate a distance and select the virtual cell in which the foot arrives, in the case of a DDR game using the device and the inventive method.

The processing operations of FIG. 5 have been described in the exemplary embodiment of the DDR game but can also be used in any context in which it is necessary to determine a direction, a line and a length of displacement of a sensor provided with at least one accelerometer. The processing operations will be particularly advantageous in all cases where the movements of the object wearing the sensor can be broken down into segments separated by moments at which said movements incorporate a relatively short pause instant during which the speed of the object is substantially zero, or incorporate a measurable impact. In practice, in the detection of the steps, it is possible either to segment between the steps by detecting the impacts or to segment by distinguishing the periods of immobility and of movement, a step then being a movement between 2 periods of immobility.

FIGS. 6a to 6f represent 6 types of displacement of a walker corresponding to 6 different positions of his shoes as detected by the inventive device in one of its embodiments.

In the figures, the positions of the feet of a walker wearing on his shoes two devices according to the invention, such as two MotionPods each comprising an accelerometer and a magnetometer, are used to control his progress over a so-called “hiking” travel in a mountain scene. The game scenario is arranged to give the player the impression that he is moving around in a scene that he sees through a virtual camera, the advancing movements in the scene being represented via said virtual camera and controlled by his feet instrumented by the sensors as represented in the 6 figures:
in FIG. 6a, a movement of both feet to the right (north east) commands a change of direction of the walker to the right;
in FIG. 6b, a movement of both feet to the left (north west) commands a change of direction of the walker to the left;
in FIG. 6c, a splayed separation of the two feet commands a backward displacement of the walker (south);
in FIG. 6d, the walker keeps both feet parallel and in the initial direction and moves forward (north);
in FIG. 6e, the walker lifts one of his heels by a pitch angle which should be greater than a predetermined value (advantageously chosen as indicated in the figure to be 20 to 30°) and his speed increases;
in FIG. 6f, the walker lifts one of his heels by a pitch angle less than the predetermined value indicated above and his speed decreases.

Obviously, the yaw movements of FIGS. 6a, 6b, 6c or 6d and the pitch movements of FIGS. 6e and 6f are combined to jointly determine the direction and the speed of the movement of advance. If the player makes no movement with his heels, he does not advance in the scene, but his angle of view of said scene is altered according to the orientation of his feet.

FIG. 6c represents an angle 610c which has to be reached or exceeded for the command to be taken into account. Similarly, thresholds are set for the commands of the other figures to be taken into account by the processing operations which are explained as comments to FIG. 7.

FIG. 7 represents in a simplified manner the processing operations performed to detect the displacements of FIGS. 6a to 6f.

The orientation of the feet is calculated through the use of the measurements of the magnetometer in combination with those of the accelerometer. This combination allows for an attitude calculation by using the inventive method that was the subject of the PCT patent application published under the number WO2009/127561 filed by one of the applicants of the present application. This method makes it possible to estimate the orientation of an object in space from the outputs of an accelerometer and a magnetometer by calculating a transfer matrix constructed from the measurements of the two sensors and their vector product. Another possibility is to use the method described in the European patent application published under the number EP 1 985 233 also filed by one of the applicants of this application. This method makes it possible to estimate an axis of rotation of a moving object by the acquisition of physical measurements on the three axes of at least one sensor at three different instants.

To make the method more effective, it may be necessary to perform a calibration of the magnetometer.

FIG. 8 represents an embodiment of the invention in which the device is worn by a hand.

In this embodiment, the processing operations for segmentation and for determination of the direction, the line and the length of the movement are applied to the movements of the hand. The processing operations will be effective if the movements are broken down into segments separated by relatively short pauses where the hand remains substantially immobile, as in the case of a free-hand drawing by segments or the cases of playing a percussion musical instrument or conducting an orchestra.

It is possible to combine sensors on the feet and on the legs, notably in game, simulation or training scenarios where the coordination of the four limbs is an important element. Such examples include, for example, golf, tennis or ski training. In such cases, it may be necessary to complement the processing operations provided by the present invention which make it possible to characterize motions of a particular type with other processing operations which make it possible to recognize types of motions that do not exhibit these characteristics. Such motion recognition processing operations may notably use algorithms of HMM (Hidden Markov Model), DTW (Dynamic Time Warping) or LTW (Linear Time Warping) type. In the embodiments disclosed notably by the French patent applications FR09/52690 and FR09/56717 filed by the applicants of this application. In the embodiments described in the abovementioned patent applications, these algorithms offer the advantage of being able to use the same output signals from the sensors incorporated in a MotionPod as the processing operations of the present invention.

The examples described above are given to illustrate embodiments of the invention. They in no way limit the scope of the invention which is defined by the following claims.

1. A device for characterizing movements of an object comprising at least one accelerometer fastened to said object and a computation module, said computation module being capable of using the outputs of said at least one accelerometer to execute:
at least one function for segmenting said movements into individual movements between a first position and a second position, and
for each individual movement, at least one function for determining the direction and the line of displacement of said individual movement relative to at least one axis linked to the object.

2. The device for characterizing movements of an object as claimed in claim 1, wherein said first and second positions correspond to instants during which said object is substantially immobile or has been affected by an impact.

3. The device for characterizing movements of an object as claimed in claim 1, wherein the computation module is capable of also executing at least one function for calculating the length of the individual movement in the direction of movement.

4. The device for characterizing movements of an object as claimed in claim 1, wherein said object is a foot or a hand of a human being.

5. The device for characterizing movements of an object as claimed in claim 1, wherein said computation module is also capable of executing a function for assessing the conformity of the movements of the object relative to at least one sequence of prerecorded movements.

6. The device for characterizing movements of an object as claimed in claim 1, wherein said computation module is also capable of executing a function for controlling the displacements of a virtual object representing the object in real movement on a display linked to said computation module, said displacements logically and quantitatively corresponding to said movements.

7. The device for characterizing movements of an object as claimed in claim 1, also comprising at least one magnetometer fastened to the object and wherein said computation module is capable of also using the outputs of said at least one accelerometer and of said at least one magnetometer to execute a function for determining the orientation of said object in at least one plane.

8. A method for characterizing movements of an object comprising at least one step for capturing the output signals from at least one accelerometer fastened to said object and a step for calculation by a processor, in which method, during said calculation step, the outputs from the step for capturing the output signals from at least one accelerometer are used to execute at least one function for segmenting said movements into individual movements between a first position and a second position, and, for each individual movement, at least one function for determining the direction and the line of displacement of said individual movement relative to at least one axis linked to the object.

9. The method for characterizing movements of an object as claimed in claim 8, wherein, during said calculation step, at least one function for calculating the length of the individual movement in the direction of movement is also executed.

10. The method for characterizing movements of an object as claimed in claim 8, wherein said calculation step also comprises, when the elevation of the accelerometer over the object is substantially greater than 20°, a step for calibrating the measurements output from the step for capturing the output signals from the accelerometer.

11. The method for characterizing movements of an object as claimed in claim 8, wherein said individual movement segmentation function comprises a step for centering on the average value of measurements output from at least one axis of the accelerometer.

12. The method for characterizing movements of an object as claimed in claim 11, wherein said individual movement segmentation function also comprises a filtering step based on calculation of at least one sliding average of said centered measurements.

13. The method for characterizing movements of an object as claimed in claim 8, wherein said step segmentation function comprises a step for calculating a norm of at least one measured or calculated value output from the accelerometer then for comparing said norm to a predetermined threshold to deduce the start or the end of the individual movement therefrom.

14. The method for characterizing movements of an object as claimed in claim 13, wherein said step segmentation function processes only the measurements over a time horizon greater than a predetermined value.

15. The method for characterizing movements of an object as claimed in claim 14, wherein said individual movement segmentation function processes only the measurements beginning at the end of a first chosen time interval following the start of an individual movement and ending at the start of a second chosen time interval preceding the end of said individual movement.

16. The method for characterizing movements of an object as claimed in claim 13, wherein said function for determining the direction of the individual movement comprises a step for calculating the maxima of the absolute values of the integrals of the measurements along each of the two axes substantially parallel to the plane of the individual movements on the signal sample determined at the output of the individual movement segmentation function, then a step for comparing the maximum along one of the axes with the maximum on the other axis, the direction of the individual movement being determined as being that of the axis of the maximum.

17. The method for characterizing movements of an object as claimed in claim 13, wherein said function for determining the direction of the individual movement comprises a step for calculating the maxima of the absolute values of the integrals of the measurements along each of the two axes substantially parallel to the plane of the individual movements on the signal sample determined at the output of the individual movement segmentation function, then a step for calculating the ratio of the maxima along the two axes, the direction of the individual movement being determined as forming an angle with the axis whose maximum is the denominator of said ratio for which the tangent is equal to said ratio.

18. The method for characterizing movements of an object as claimed in claim 16, wherein said function for determining the line of the individual movement comprises, at the output of the step for determining the direction of the individual movement, a step for determining the signs of the maxima along said two axes, said sign determining the line of the individual movement in the determined direction.

19. The method for characterizing movements of an object as claimed in claim 16, wherein said function for calculating the length of the individual movement comprises a step for double integration of the absolute values of the measurements according to the direction of the individual movement determined at the output of the function for determining the direction and the line of the individual movement.

20. System for evaluating the movements of an object comprising:
A master scenario of reference movements to be executed by said object,
A control interface of said reference movements of said object,
At least one first uniform field sensor, said sensor being fastened to said object,
A calculation module, said module being capable to execute from the output of said first sensor:
at least one function for segmenting said movements into individual movements between a first position and a second position, and
for each individual movement, at least one function for determining the direction and the line of displacement of said individual movement relative to at least one axis linked to the object,
said movements of said object being executed in response to said reference movements.
